(19) United States
(12) Patent Application Publication
(10) Pub. No.: US 2005/0007713 A1
(43) Pub. Date: Jan. 13, 2005

(54) CONTROL CIRCUIT OF VOLTAGE SAG IMMUNITY

(76) Inventors: Wen-Chang Chang, Hsin-Chu City (TW); Chin-Hsing Chiu, Miao- Li Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,288

(22) Filed: Jul. 8, 2003

(51) Int. Cl. H02H 3/24

(52) U.S. Cl. 361/92

(57) ABSTRACT

A control circuit for preventing equipment from being damaged by voltage sag uses a modular circuit having a rectifier, an electricity storing device or a control relay to perform functions of charging, discharging, and controlling. The modular circuit can be applied to control circuits of all equipment for increasing stability of the equipment. When a power source of the control circuit has voltage sag, the electricity storing device discharges for assisting a winding of a magnetic switch in riding through a temporary period of demagnetization. Consequently, the main connections keep contact for preventing the power source from being broken and also preventing the equipment from being damaged.

### BACKGROUND OF INVENTION

1. Field of the Invention

The present invention relates to a control circuit, and more specifically, to a control circuit for preventing equipment from being damaged by voltage sag.

2. Description of the Prior Art

In the semiconductor industry, equipment utilized for manufacturing are extremely sensitive and would shut down by voltage sag, frequently leading to addition cost burden for production. Therefore, it turns to be a very important issue to maintain a stable power source of equipment.

Please refer to FIG. 1 of a schematic view of a control circuit 10 according to the prior art. As shown in FIG. 1, the control circuit 10 is installed in equipment 22 and includes a magnetic switch 13, a normal open connection 16 and at least one main connection 17. Two terminals A and B of the control circuit 10 are electrically connected to two terminals A″ and B″ of a main power source 12 respectively, and the control circuit 10 further includes a turn-on button 18 and a shutdown button 20 respectively for conducting and disconnecting an alternating current (AC) generated by the main power source 12 to the control circuit 10. Since the normal open connection is a continuous connection, the AC current generated by the main power source 12 can be supplied to the winding 14 via the normal open connection in case that the turn-on button 18 is loosen. The main connection 17 is electrically connected to the main power source 12 and therefore 12 and therefore supplies the AC current generated by the main power source 12 to enable the operation of the equipment 22. Similarly, the equipment 22 is can be shut down by pressing the shutdown button 20 to disconnect the AC power generated by the main power source 12 to the winding 14, making the magnetic field disappeared. As a result, the normal open connection 16 and the main connection 17 disconnected from each other, keeping the AC power generated by the main power source 12 away from the equipment 22.

However, voltage sag of the control circuit 12 may occasionally occur due to the unstable power supplied to the control circuit 12 and lower the magnetic field generated by the current in the winding 14, leading to the disconnection between the normal open connection 16 and the main connection 17 that leads to the shut-down of the equipment 22. As a result, the operating cost of the factory would be seriously increased.

### SUMMARY OF INVENTION

It is therefore a primary object of the present invention to provide a control circuit so as to prevent equipment from being damaged by voltage sag.

According to the claimed invention, the control circuit includes a turn-on button, a magnetic switch and a modular circuit. The magnetic switch includes a winding, a normal open connection and at least one main connection, and the modular circuit includes a rectifier and a electricity storing device for providing direct current (DC) to the control circuit. The electricity storing is discharged to prevent the disconnection between the normal open connection and the main connection as voltage sag occurs.

It is an advantage of the present invention against the prior art that the control circuit provided in the present invention prevents shutdown of equipment and relative increase in production cost caused by voltage sag by the discharge of the electricity storing device for ensuring the electrical connection between the normal open connection and the main connection during voltage sag. In addition, the modular circuit according to the present invention is capable of being directly embedded in the control circuit. The manufacturing processes are therefore simplified.

These and other objectives of the present invention will no doubt become obvious to those of ordinary skill in the art after reading the following detailed description of the preferred embodiment, which is illustrated in the multiple figures and drawings.

### BRIEF DESCRIPTION OF DRAWINGS

FIG. 1 is a schematic view of a control circuit according to the prior art.

FIG. 2 is the schematic view of a control circuit according to the preferred embodiment of the present invention.

FIG. 3 is the schematic view of a control circuit according to the second embodiment of the present invention.

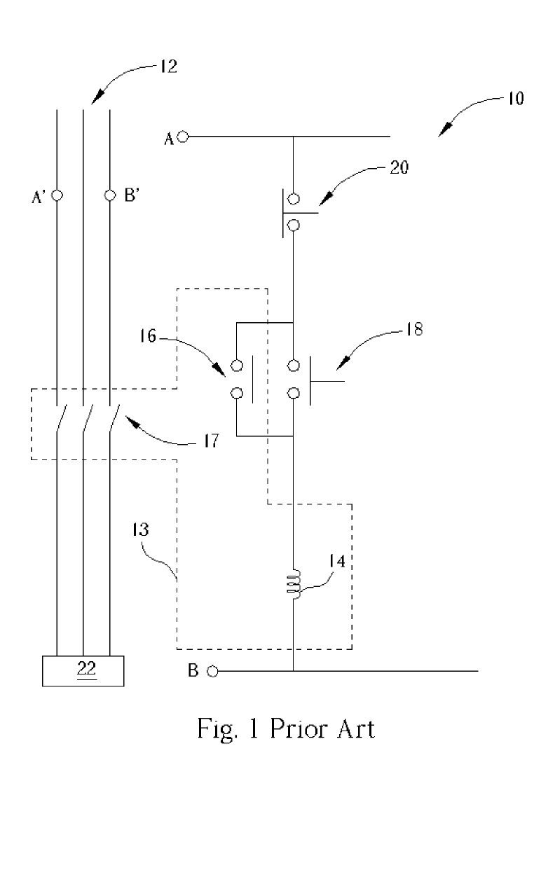

### DETAILED DESCRIPTION

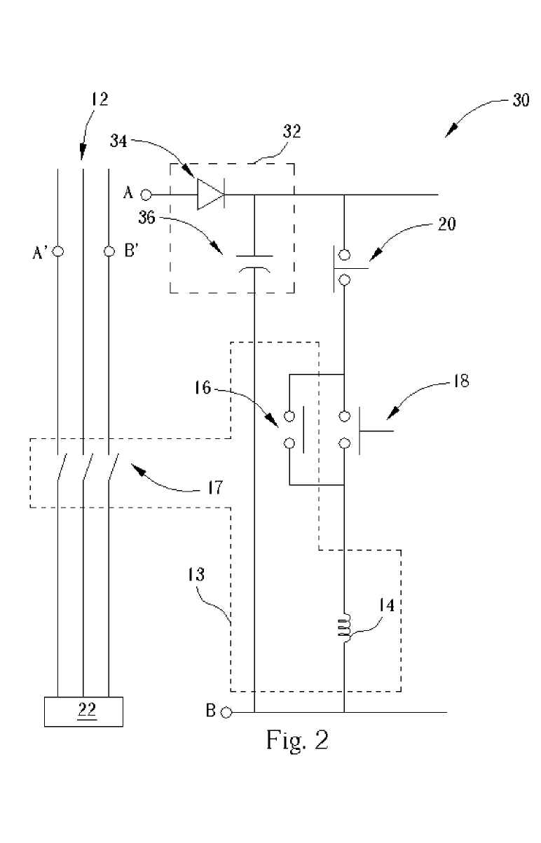

Please refer to FIG. 2 of a schematic view of a control circuit 30 installed in equipment 22 according to a first embodiment of the present invention. As shown in FIG. 2, the control circuit 30 includes a magnetic switch 13 and a modular circuit 32, and two terminals A and B of the control circuit 30 are electrically connected to two terminals A″ and B″ of a main power source 12, respectively. The magnetic switch 13 includes a winding 14, a normal opening connection 16 and at least one main connection 17, and the modular circuit 32 includes a rectifier 34 and an electricity storing device 36, such as a capacitor or a rechargeable battery. In addition, the control circuit 30 further includes a turn-on button 18 and a shutdown button 20 respectively for connecting and disconnecting the control circuit 30 with current generated by the main power source 12.

According to the first embodiment of the present invention, by pressing the turn-on button 18, an alternating current (AC) is generated by the main power source 12, converted to a direct current (DC) by the rectifier 34 and supplied to the control circuit 30 thereafter. The direct current passes the winding 14 of the magnetic switch 13 to make the main connection 17 and the normal open connection 16 connected to each other, enabling the current generated by the main power source 12 to be supplied to the equipment 22. Simultaneously, the electricity storing device 36 is charged by the direct current converted from the alternating current generated by the main power source 12. In other words, the electrical power provided by the main power source 12 is not only supplied to the equipment 22, but also employed for the charging of the electricity storing device 36.

As voltage sag of the main power source 12 occurs, the electricity storing device 36 is discharged to provide the direct current to the control circuit 30, thus preventing the disconnection between the normal open connection 16 and the main connection 17 and ensuring the alternating current generated by the main power source 12 to be supplied to the equipment 22 for normal operation.

Since voltage sag, even having a duration for just a few seconds, of the main power source 12 frequently causes the disconnection between the normal open connection 16 and the main connection 17 and therefore leads to shutdown of the equipment and relative burden for production cost, the primary object of the electricity storing device 36 revealed in the present invention is to continuously supply current to the winding 14 as voltage sag occurs. The disconnection between the normal open connection 16 and the main connection 17 is thus prevented, and the normal operation of the equipment 22 is ensured as well.

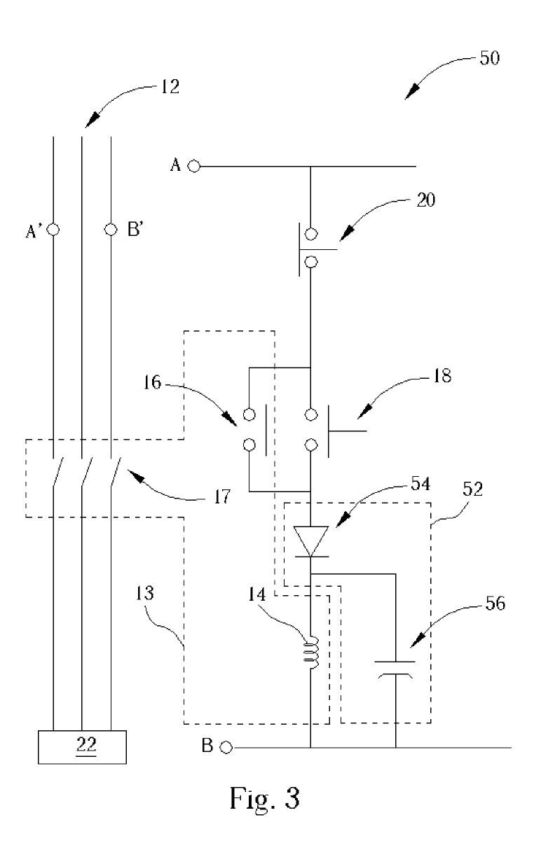

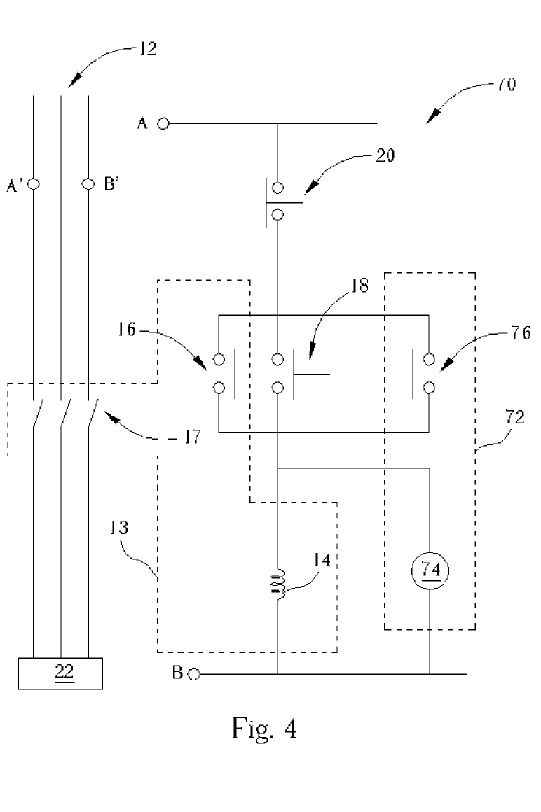

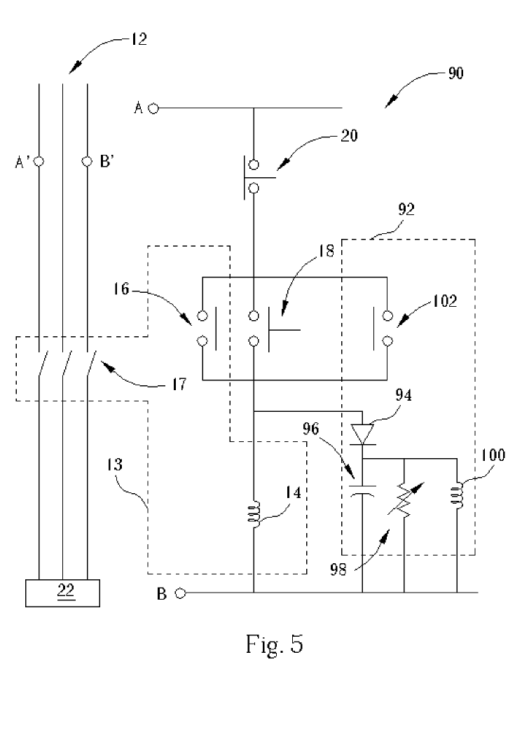

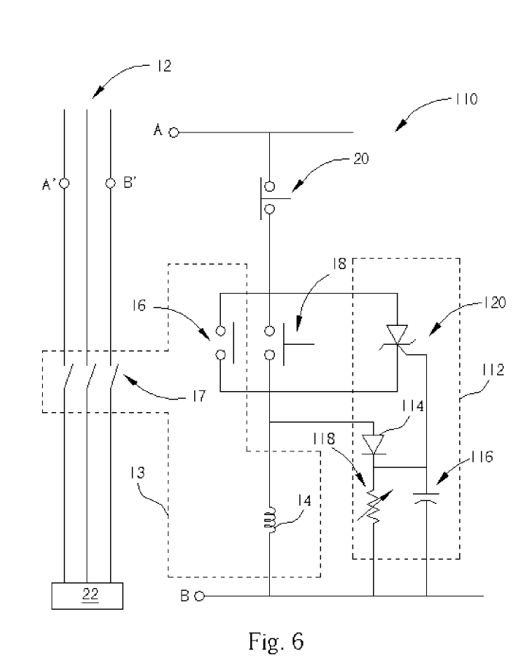

Please refer to FIG. 3 of the schematic view of a control circuit 50 installed in equipment 22 according to a second embodiment of the present invention. As shown in FIG. 3, the control circuit 50 includes a magnetic switch 13 and a modular circuit 52, and two terminals A and B of the control circuit 50 are electrically connected to two terminals A″ and B″ of a main power source 12, respectively. The magnetic switch 13 includes a winding 14, a normal opening connection 16 and at least one main connection 17, and the modular circuit 32 includes a rectifier 54 and an electricity storing device 56, such as a capacitor or a rechargeable battery. In addition, the control circuit 50 further includes a turn-on button 18 and a shutdown button 20 respectively for connecting and disconnecting the control circuit 50 with an alternating current generated by the main power source 12.

According to the second embodiment of the present invention, by pressing the turn-on button 18, the alternating current is generated by the main power source 12, converted to a direct current by the rectifier 54 and supplied to the winding 14 thereafter. In other words, the control circuit 50 partly uses the direct current for operation. Simultaneously, the electricity storing device 56 is charged by the current generated by the main power source 12. As voltage sag of the main power source 12 occurs, the electricity storing device 56 is discharged to provide the direct current to the winding 14, thus preventing the disconnection between the normal open connection 16 and the main connection 17 and ensuring the alternating current generated by the main power source 12 to be supplied to the equipment 22 for normal operation.

In comparison with the control circuit revealed in the prior art, the control circuit provided in the present invention prevents shutdown of the equipment and relative increase in production cost caused by voltage sag by the discharge of the electricity storing device for ensuring the electrical connection between the normal open connection and the main connection during voltage sag. In addition, the modular circuit according to the present invention is capable of being directly embedded in the control circuit. The manufacturing processes are therefore simplified.

Those skilled in the art will readily observe that numerous modifications and alterations of the device may be made while retaining the teachings of the invention. Accordingly, the above disclosure should be construed as limited only by the metes and bound of the appended claims.

1. A control circuit for preventing equipment from being damaged by voltage sag comprising:
a turn-on button;
a magnetic switch comprising a winding, an normal open connection and at least one main connection, the normal open connection and the main connection electrically connecting to circuits of a main power source through a magnetic field generated by a current supplied to the winding so as to provide power to at least one equipment; and
a modular circuit comprising a rectifier and a electricity storing device, the rectifier providing a direct current (DC) to the control circuit;
wherein the electricity storing device is charged with the DC current as the DC current is conducted to the control circuit by the turn-on button of the control circuit, and is discharged to supply current to the winding as voltage sag occurs for preventing the disconnection between the normal open connection and the main connection.

2. The control circuit of claim 1 wherein the control circuit further comprises a shutdown button for disconnecting the DC current to the control circuit.

3. The control circuit of claim 1 wherein the control circuit further comprises a main power source for providing alternating current (AC) to the modular circuit.

4. The control circuit of claim 1 wherein the electricity storing device is a capacitor.

5. The control circuit of claim 1 wherein the electricity storing device is a rechargeable battery.

6. A control circuit for preventing equipment from being damaged by voltage sag comprising:
a turn-on button;
a magnetic switch comprising a winding, an normal open connection and at least one main connection, the normal open connection and the main connection electrically connecting to circuits of a main power source through a magnetic field generated by a current supplied to the winding so as to provide power to at least one equipment; and
a modular circuit comprising a rectifier and a electricity storing device;
wherein an AC current of the main power source is conducted to the control circuit by the turn-on button, the electricity storing device is charged with a DC current rectified from the AC current by utilizing the rectifier, and is discharged to supply current to the winding as voltage sag occurs for preventing the disconnection between the normal open connection and the main connection.

7. The control circuit of claim 6 wherein the control circuit further comprises a shutdown button for disconnecting the AC current to the control circuit.

8. The control circuit of claim 6 wherein the electricity storing device is a capacitor.

9. The control circuit of claim 6 wherein the electricity storing device is a rechargeable battery.
